(19) United States
(12) Patent Application Publication
(10) Pub. No.: US 2017/0349301 A1
(43) Pub. Date: Dec. 7, 2017

(54) SEVERE WEATHER AGILITY THRUSTERS, AND ASSOCIATED SYSTEMS AND METHODS

(71) Applicant: Blue Origin, LLC, Kent, WA (US)

(72) Inventors: Jeffrey P. Bezos, Kent, WA (US); Richard Jones, Kent, WA (US)

(21) Appl. No.: 15/611,189

(22) Filed: Jun. 1, 2017

Related U.S. Application Data
(60) Provisional application No. 62/344,288, filed on Jun. 1, 2016.

(51) Int. Cl. B64G 1/00; B64G 1/62; B64G 1/40

(52) U.S. Cl. CPC B64G 1/002; B64G 1/40; B64G 1/62

(57) ABSTRACT

Severe weather agility thrusters, and associated systems and methods are disclosed. A representative system includes a launch vehicle having a first end and a second end generally opposite the first end, and is elongated along a vehicle axis extending between the first and second ends. A propulsion system is carried by the launch vehicle and has at least one main engine having a corresponding nozzle positioned toward the first end to launch the launch vehicle. At least one laterally-directed thruster is positioned toward the second end of the launch vehicle. The system further includes a controller in communication with the launch vehicle and programmed with instructions that, when executed, direct the launch vehicle in a first direction during vehicle ascent, direct the launch vehicle in a second direction, opposite the first direction, during vehicle descent, and direct activation of the at least one laterally-directed thruster to guide the launch vehicle during descent.

### CROSS-REFERENCE TO RELATED APPLICATION

The present application claims priority to pending U.S. Provisional Application No. 62/344,288, filed Jun. 1, 2016 and incorporated herein by reference in its entirety.

### TECHNICAL FIELD

The present technology relates to severe weather agility thrusters, and associated systems and methods. Embodiments of the technology include rocket boosters with forward, laterally-directed thrusters.

### BACKGROUND

Rocket manufacturers continually strive to reduce the cost of launching a payload into space. One approach for reducing such costs is to retrieve one or more booster stages used to propel the rocket to space. In a particular approach, the booster is landed vertically and then refurbished for another launch. One drawback with this approach is that it may be difficult to control the booster during landing operations under particular conditions. Accordingly, there remains a need in the art for improved booster retrieval techniques.

### BRIEF DESCRIPTION OF THE DRAWINGS

FIG. 1A is a partially schematic, side elevation view of a system including a multi-stage launch vehicle having a first stage with laterally-directed thrusters configured in accordance with an embodiment of the present technology.

FIG. 1B illustrates an embodiment of the first stage shown in FIG. 1A, with landing gear deployed in accordance with an embodiment of the present technology.

FIG. 1C illustrates a portion of the first stage shown in FIG. 1B, with multiple laterally-directed thrusters positioned in accordance with another embodiment of the present technology.

FIG. 1D is a partially schematic, top isometric illustration of the vehicle shown in FIG. 1A.

FIG. 1E is a partially schematic view of the first stage shown in FIG. 1B.

FIGS. 2A-2C illustrate aerodynamic coefficients and associated cubic fit curves.

FIG. 2D is a partially schematic illustration of a representative vehicle configured in accordance with an embodiment of the present technology.

FIG. 3 illustrates achievable distance values as a function of environmental wind speed for a variety of relative wind conditions, in accordance with embodiments of the present technology.

FIGS. 4A-4B illustrate results from a simulation of a vehicle using laterally-directed thrusters and a center main engine in accordance with an embodiment of the present technology.

FIGS. 5A-5B illustrate results from a simulation of a vehicle using laterally-directed thrusters and a down-wind main engine, in accordance with an embodiment of the present technology.

FIGS. 6A-6B illustrate results from a simulation of a vehicle using an up-wind main engine and laterally-directed thrusters in accordance with an embodiment of the present technology.

FIGS. 7A-7C illustrate pitch angle, thrust vector control angle, and laterally-directed thruster force, respectively, as a function of relative wind speed based on a simulation of a vehicle in accordance with an embodiment of the present technology.

FIGS. 8A-8C illustrate fourth and fifth order curve fits for developing data used in an aerodynamic model in accordance with an embodiment of the present technology.

FIGS. 9A-9B illustrate thrust vector control angle and laterally-directed thruster force, respectively, as a function of relative wind, for multiple vehicle pitch angles, for operation with a center main engine and laterally-directed thruster, in accordance with an embodiment of the present technology.

FIGS. 10A-10B illustrate thrust vector control angle and laterally-directed thruster force, respectively, as a function of relative wind, for multiple vehicle pitch angles, for operation with a down-wind main engine and laterally-directed thruster, in accordance with an embodiment of the present technology.

FIGS. 11A-11B illustrate thrust vector control angle and laterally-directed thruster force, respectively, as a function of relative wind, for multiple vehicle pitch angles, for operation with an up-wind main engine and laterally-directed thruster, in accordance with an embodiment of the present technology.

FIGS. 12A-12C illustrate vehicle pitch angle, thrust vector control angle, and thrust level, respectively as a function of relative wind, for operation with a center main engine, up-wind main engine, and down-wind main engine, in accordance with an embodiment of the present technology.

FIGS. 13A-13B illustrate a main engine nozzle, thruster, and isolation valves for a rocket configured in accordance with embodiments of the present technology.

FIGS. 14A and 14B illustrate rocket configurations having 12 and 48, respectively, forward-mounted side-directed thrusters in accordance with embodiments of the present technology.

FIG. 15 illustrates a control mixer configured in accordance with the embodiments of the present technology.

### DETAILED DESCRIPTION

Embodiments of the technology disclosed herein are directed to rocket boosters with forward, laterally-directed thrusters, and associated systems and methods. In particular embodiments, the boosters include one or more main engines (positioned toward the bottom of the booster) that propel the rocket upwardly during ascent. In addition, the booster can include one or more thrusters that are directed laterally (e.g., at least in part), and are positioned away from the bottom of the booster to stabilize the booster during a powered, vertical landing operation. As the booster descends (after boosting the payload upwardly), the laterally-directed thrusters are fired to orient or help orient the booster in a target (e.g., upright) configuration during a vertical, “tail-down” landing. In particular embodiments, this arrangement gives the booster additional stability and control, with further stability and control provided by gimballing the main engine(s) of the booster.

The foregoing arrangement can produce one or more of multiple benefits. For example, one expected benefit is that the booster can more efficiently translate laterally prior to touchdown. In particular, with the aid of the laterally-directed thrusters, the booster can more efficiently move side-to-side to position itself directly over a target landing spot. The laterally-directed thrusters are smaller, lighter and use less fuel than the larger main engines and can accordingly perform or aid in performing the lateral translation maneuver with less fuel and/or increased cross-range.

Another expected advantage of the foregoing configuration is that it can enable the booster to land even when the main engine power provided during landing is provided by an off-axis main engine. For example, on a booster with multiple main engines, typically the center engine is the only one that provides thrust aligned axially through the booster's center of mass. Accordingly, the center engine is typically the only main engine used to land the booster (or alternatively, all main engines are used to land the booster), so as to avoid thrust vectors that do not pass through the booster's center of mass. In many cases, any single engine other than the center engine (e.g., an outboard engine) will not gimbal far enough to maintain the booster upright for the landing maneuver. Accordingly, if the center engine is the only engine that can land the booster, the whole booster will be lost if the center engine fails to operate. However, with the added lateral thrust provided by the laterally-directed thrusters, an off-axis or outboard engine can be used to safely land the booster, for example, if the center engine fails to reignite, or is otherwise inoperable.

Still another expected advantage of the foregoing arrangement is that the laterally-directed thrusters can expand the envelope of wind conditions under which the booster can safely land without tipping over. In particular, the laterally-directed thrusters can be activated and deactivated at a rate rapid enough to accommodate gusty winds. Because the laterally-directed thrusters can be positioned toward the top of the booster stage, they can provide a long moment arm relative to the booster's center of mass and accordingly, the relatively small amount of thrust they provide can result in a large reorientation moment. Furthermore, the additional stability provided by the laterally-directed thrusters can allow the booster to employ smaller and lighter landing gear because the landing gear can be sized to accommodate smaller maximum tilt angles. In addition, the laterally-directed thrusters can operate even after the booster has touched down to keep the landed booster from being knocked over by strong winds while it is being secured to the ground, sea-landing platform, and/or other landing platform.

The foregoing features can allow the booster to operate in a wider variety of environmental conditions (e.g., the booster can have an “all-weather” and/or severe weather capability). In addition, the booster can have a high availability, meaning that it can have a broader operational envelope, not only with regard to weather conditions, but also engine-out and/or other non-weather related conditions.

The foregoing features and associated systems (which are described in further detail below), differ from the typical reaction control system (RCS) devices used on conventional space vehicles. Such RCS devices are designed to operate in the vacuum of space, where external forces such as wind and gravity are non-existent or significantly reduced—in contrast to the terrestrial environment in which the presently disclosed booster lands prior to re-use. As a result, conventional RCS devices produce relatively low levels of thrust, are not positioned to facilitate a tail-down landing, and/or are not configured to respond to intermittent and/or variable loads, such as those produced by wind. In addition, conventional RCS devices are typically configured to rotate the space vehicle about one or more axes. By contrast, embodiments of the present technology include thrusters positioned and controlled to translate the booster, e.g., laterally, to properly align it with a landing site during the terminal stages of a tail-down landing maneuver. In such cases, it may be advantageous to translate the booster rather than re-orient the booster. For example, conventional techniques for re-orienting a space vehicle typically requires a first angular re-orientation, followed by travel along the new vector, followed by a second angular re-orientation back to the original attitude. Simply translating the booster, by using the laterally-directed thrusters in combination with one or more main engines, can position the vehicle properly with fewer steps. This result can be important, given (a) the proximity of the booster to the ground, and/or (b) the limited amount of on-board fuel, both of which factors can limit the opportunities for maneuvering the booster.

In another example, the lateral translation will be accompanied by a longitudinal translation (e.g., an upward translation). In both examples, the attitude of the space vehicle can remain generally the same as it undergoes the translation. For example, the space vehicle can remain pointed upwards as it is translated. As discussed above, this approach can eliminate the need to pivot the space vehicle away from its initial attitude in order to accomplish the desired lateral motion, and then reverse pivot the space vehicle back to its original attitude, e.g., for a tail down landing. In operation, the attitude may change slightly, but is expected to be within 2 degrees of the initial or target attitude (i.e., generally the same). The target attitude can be vertical (e.g., for landing on a flat surface) or non-vertical (e.g., for landing on a pitching/rolling ship deck).

### 1.0 Representative System

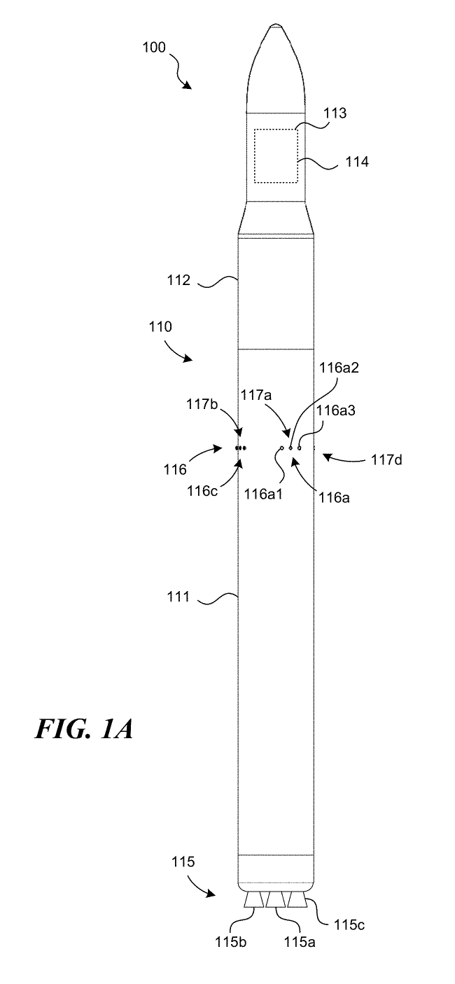

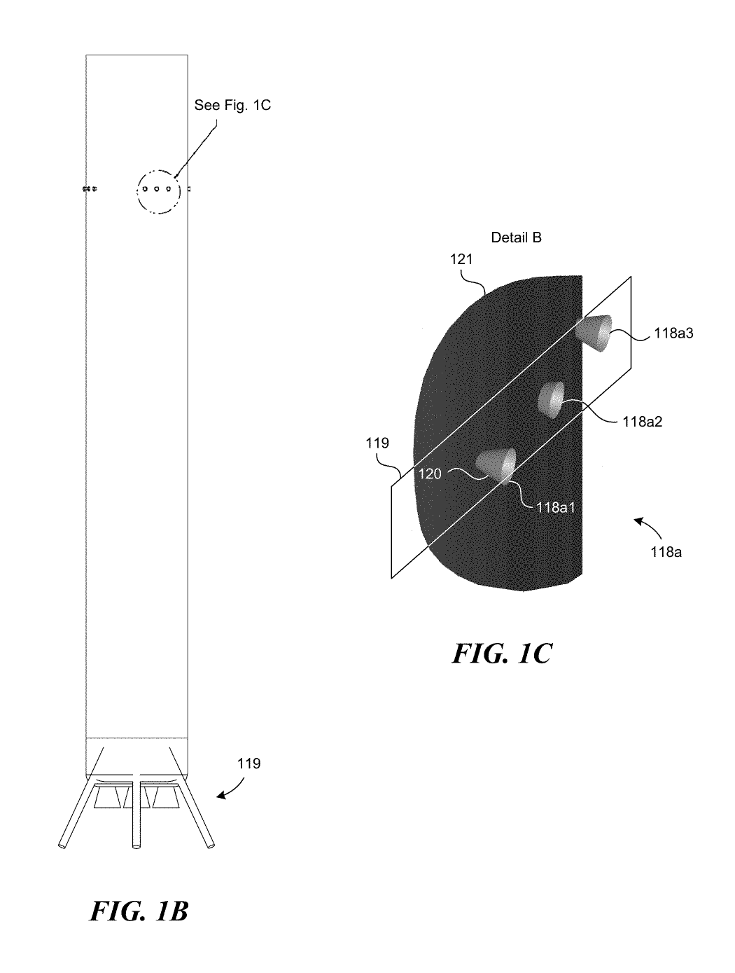

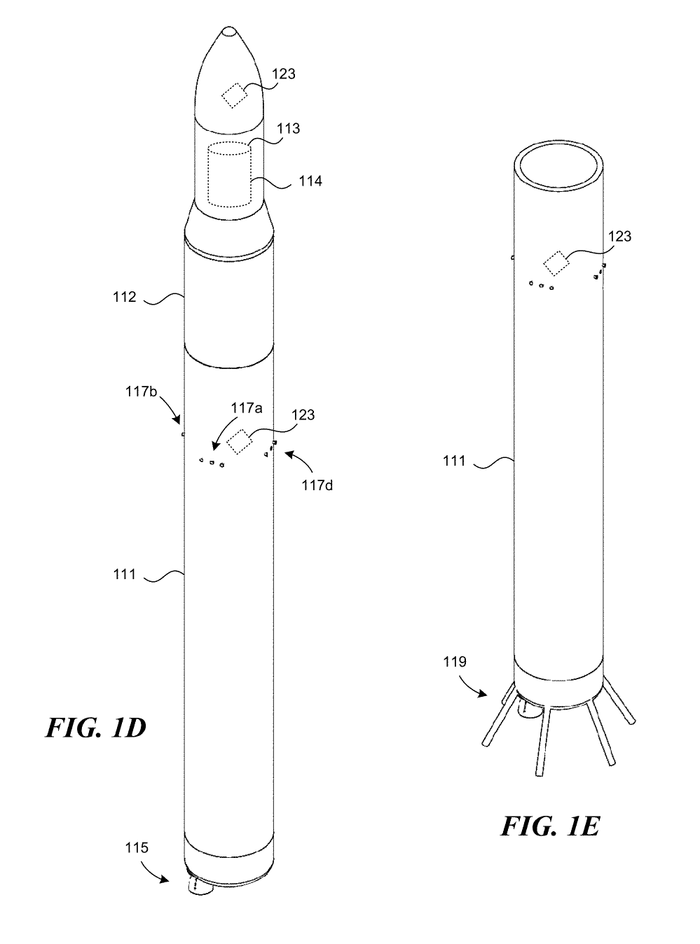

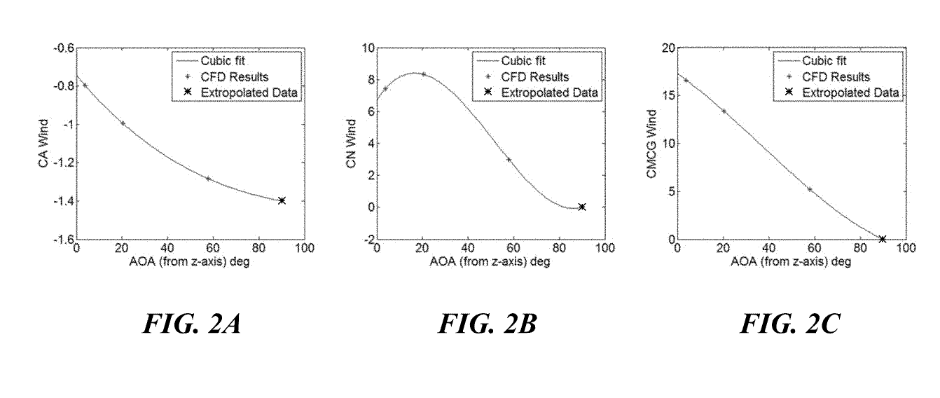

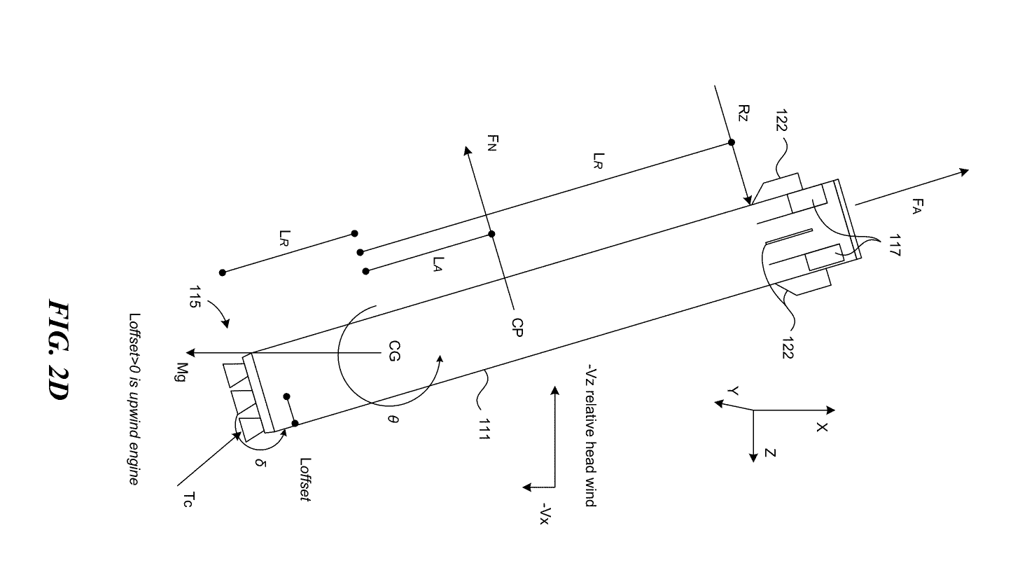

FIGS. 1A-1E illustrate a representative system 100 configured in accordance with an embodiment of the present technology. The system 100 can include a vehicle 110 (e.g., a launch vehicle) having a multi-stage configuration. Accordingly, the vehicle 110 can include a first stage 111, a second stage 112, and a payload 113 (shown schematically in FIG. 1A) surrounded by a fairing 114. The first stage 111 and second stage 112 operate as boosters to direct the payload 113 into space. In other embodiments, the vehicle 110 can include a single booster or more than two boosters. In any of these embodiments, at least one of the boosters (e.g., the first stage 111) is configured to be returned to earth in a tail-down configuration and is then re-used on a subsequent launch.

The first stage 111 can include a propulsion system that can in turn include one or more main engines 115, illustrated as a first or central main engine 115a and multiple outboard main engines 115b, 115c. During launch, the main engines 115 provide the primary motive force directing the vehicle 110 upwardly. During a tail-down reentry, the thrust provided by the main engines 115 can be augmented by one or more first stage laterally-directed thrusters 116. The laterally-directed thrusters 116 can be located a significant distance above the main engines 115, so as to provide for a large moment arm relative to the center of mass of the first stage 111 (which is located toward the bottom of the first stage 111) during a tail-down descent. The laterally-directed thrusters 116 can be positioned at multiple locations around the circumference of the first stage 111, including a first location 117a, a second location 117b, a third location (not visible in FIG. 1A) and a fourth location 117d. Each location can in turn accommodate one or more laterally-directed thrusters. For example, the first location 117a can include three laterally-directed thrusters illustrated as a first laterally-directed thruster 116a1, a second laterally-directed thruster 116a2, and a third laterally-directed thruster 116a3. In other embodiments, each location can include other numbers of laterally-directed thrusters, as will be described later.

FIG. 1B illustrates the first stage 111 with landing gear 119 deployed. FIG. 1C illustrates a detailed portion of the first stage 111 shown in FIG. 1B, in particular, illustrating the three laterally-directed thrusters 116a1, 116a2, and 116a3. Each laterally-directed thruster includes a corresponding nozzle 118a1, 118a2, and 118a3. The exits of the nozzles can be positioned in a common exit plane 120, and the extent to which each nozzle projects from the vehicle outer surface 121 can vary due to the curvature of the vehicle outer surface 121. The nozzles can have fixed positions in some embodiments, and variable positions in other embodiments. In any of these embodiments, at least a portion (e.g., all, or a significant portion) of the thrust directed by the nozzles is directed laterally, e.g., transverse to the longitudinal axis of the of the first stage 111 (and/or transverse to the axis along which the main engines direct thrust when in a non-gimballed orientation). Accordingly, and as used herein, the term laterally-directed thruster refers generally to a thruster that is different than the main engines, and that directs thrust with at least a lateral component. In particular embodiments, the laterally-directed thruster directs more thrust in a lateral direction than in a longitudinal direction. When used in combination with other lateral-thrust-producing engines (e.g., another laterally-directed thruster spaced apart along the longitudinal axis, and/or a gimballed main engine), a laterally-directed thruster can translate the vehicle 110 laterally (e.g., along a path that is purely lateral, or a path that also includes a vertical component) to position the vehicle for tail-down landing.

The laterally-directed thrusters 116 can have any of a number of suitable configurations. For example, the laterally-directed thrusters can include pumped and/or pressure-fed hydrogen peroxide systems. In particular, the laterally-directed thrusters 116 can include pump-fed thrusters or pressure-fed thrusters. In other embodiments, the laterally-directed thrusters can include “warm gas” pressure-fed thrusters, or “warm gas” pressure-fed ejector thrusters. In particular, one embodiment includes a small, printable pressure-fed ejector thruster that provides suitable performance and fault tolerance.

FIGS. 1D and 1E illustrate top isometric illustrations of the vehicle 110 and the first stage 111, respectively, shown in FIGS. 1A and 1B, respectively, both of which schematically illustrate controllers 123. In any of the vehicle embodiments described herein, the control functions can be directed by a computer or computer-based controller. Accordingly, many embodiments of the technology described below may take the form of computer- or controller-executable instructions, including routines executed by a programmable computer or controller. Those skilled in the relevant art will appreciate that the technology can be practiced on computer/controller systems other than those shown and described below. The technology can be embodied in a special-purpose computer, controller or data processor that is specifically programmed, configured or constructed to perform one or more of the computer-executable instructions described below. Accordingly, the terms “computer” and “controller” as generally used herein refer to any data processor and can include, in at least some embodiments, Internet appliances and hand-held devices (including palm-top computers, wearable computers, cellular or mobile phones, multi-processor systems, processor-based or programmable consumer electronics, network computers, mini computers and the like). Information handled by these computers can be presented at any suitable display medium, including a CRT display or LCD.

The technology can also be practiced in distributed environments, where tasks or modules are performed by remote processing devices that are linked through a communications network. In a distributed computing environment, program modules or subroutines may be located in local and remote memory storage devices. The distributed environment can include devices carried on-board the vehicle and/or off-board the vehicle. Aspects of the technology described below may be stored or distributed on computer-readable media, including magnetic or optically readable or removable computer disks, as well as distributed electronically over networks. Data structures and transmissions of data particular to aspects of the technology are also encompassed within the scope of the embodiments of the technology.

Several computer-based simulations have been conducted to assess the feasibility and efficacy of rocket vehicle configurations having arrangements generally similar to those discussed above with reference to FIGS. 1A-1E. A first set of simulations was conducted to determine the ability of a representative configuration having forward-mounted, laterally-directed thrusters to trim the vehicle during a vertical, tail-down landing maneuver, in conjunction with an operable center main engine, or a down-wind main engine, or an up-wind main engine. A second simulation was conducted to analyze the ability of multiple laterally-directed thrusters pointing in the same direction to trim the vehicle during landing. A third simulation was conducted to compare results using 12 thrusters (each having a variable thrust level) with results using 48 thrusters (each of which has a binary thrust level). The foregoing simulations are described serially below.

### 2.0 First Simulations

This section addresses the control authority of a representative rocket configuration and the expected robustness requirements and limitations of landing the first stage of the rocket while subjected to a variety of relative winds, in accordance with particular embodiments. This section assesses the landing performance using either the nominal center main engine or a non-center main engine (e.g., in the event of a center main engine failure to restart). Trajectory and vehicle attitude control is facilitated by main engine thrust variation, limited thrust vector control (TVC) angle, and laterally-directed thrusters.

This analysis is focused on the terminal thrust=weight (T=W) condition. A nonlinear, but simplified three-degree-of-freedom (3DOF) planner aerodynamic model for a vehicle was developed from a curve fitted computational fluid dynamics (CFD) analysis. An optimizer was used to trim the vehicle against varying relative headwinds to find the required TVC angle, main engine thrust, and laterally-directed thruster forces for trimmed vertical landing (e.g., with a fixed or changing pitch angle to match the landing platform deck angle, which may be fixed or changing). Then an optimizer was used to find a selected (e.g., optimum) pitch angle and TVC angle to achieve a low (e.g., minimal) laterally-directed thruster requirement to trim against varying relative headwinds. This approach was used to assess the cross-range capability of the vehicle during T=W operations. These trades are repeated for the center main engine and both up-wind and down-wind outboard main engine cases to determine the robustness of the system to center engine failure.

The simplified aerodynamic model and center of gravity (CG) location used in this analysis was very stable about the vehicle −x axis (in decent) at low subsonic speeds. As such, the vehicle tends to weathercock (by large pitching moments) into side winds, making it difficult to trim the landing vehicle in a vertical orientation given limited TVC authority even with a laterally-directed thruster contribution. These limits are particularly difficult when an off-center main engine is used. The pitching moment due to side winds and the limited TVC authority also place an upper bound on the largest relative side wind against which the vehicle can trim, even if the pitch angle is not fixed to some value for landing.

### 2.1 Assumptions

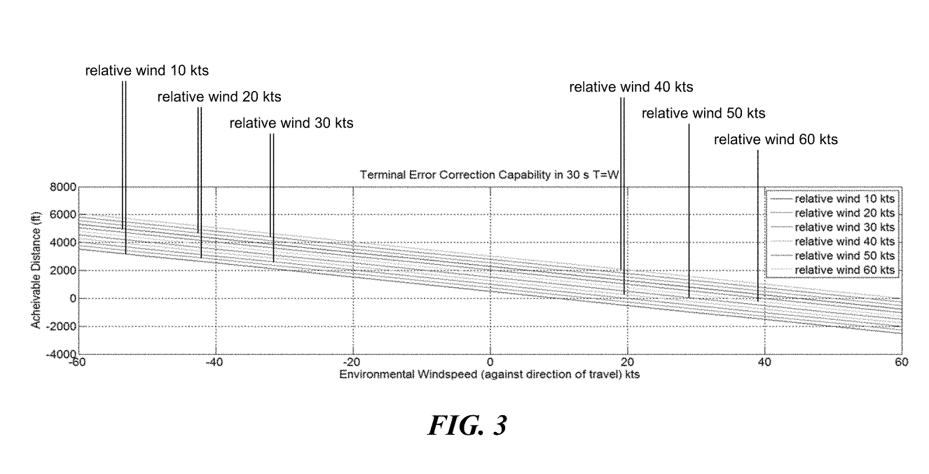

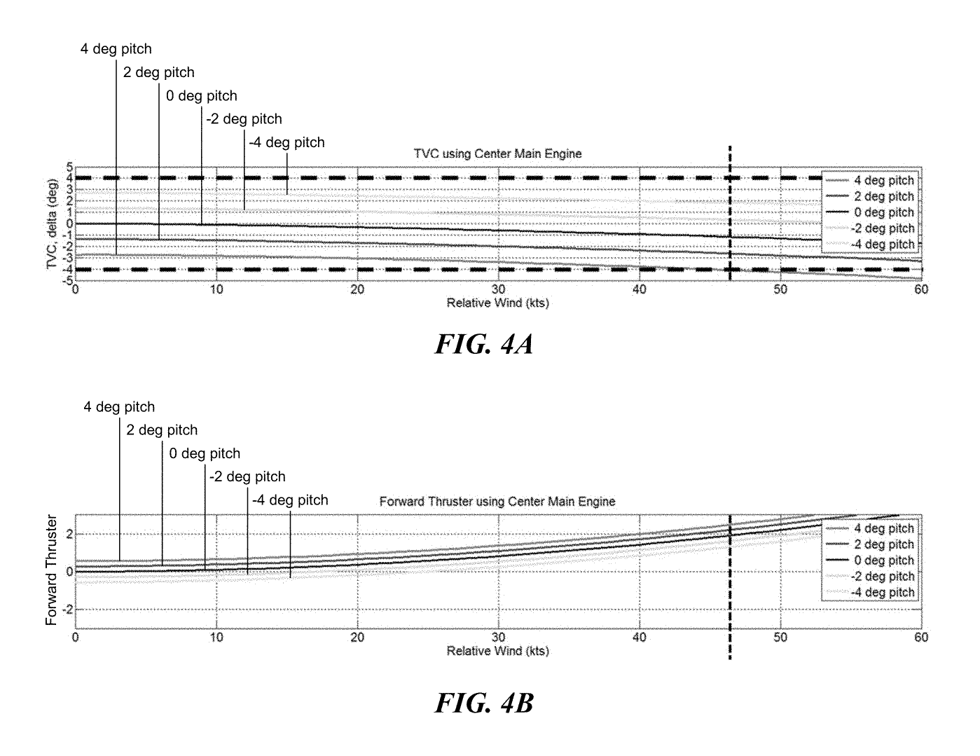

For the purpose of developing an approximated aerodynamic model, a set of limited CFD data was used. The aerodynamic coefficients were referenced to a representative CG location. The aerodynamic coefficients were fit to cubic equations (FIGS. 2A, 2B, 2C) for simplification and to fill out the aerodynamic model. A change of reference angle of attack (AOA) was used to aid curve fitting. This new reference uses AOA defined as the angle between the relative wind vector and the vehicle positive Z axis (called α₀), as shown in FIG. 2D. The first stage 111 shown in FIG. 2D is generally similar to that shown in FIGS. 1A-1E, but also includes fins 122. It should be noted that the normal vehicle AOA is defined as the angle between relative wind and the vehicle positive X axis (called α).

Three degree of freedom (3DOF) equations were balanced to achieve a trim and basic vehicle model, as shown below:

$$\begin{matrix}- {T}_{c} sin ( θ + δ ) + {R}_{z} cos ( θ ) - {F}_{N} ( α , V ) cos ( θ ) - {F}_{A} ( α , V ) sin ( θ ) = 0 & ( 1 ) \\ - {T}_{c} {L}_{c} sin ( δ ) + {T}_{c} {L}_{offset} cos ( δ ) - {R}_{z} {L}_{R} + M ( α , V ) + {L}_{A} {F}_{N} ( α , V ) = 0 & ( 2 ) \\ {T}_{c} cos ( θ + δ ) - mg - {F}_{N} ( α , V ) sin ( θ ) + {F}_{A} ( α , V ) cos ( θ ) = 0 & ( 3 ) \\ {L}_{A} = 70 - {CG}_{x} & ( 4 ) \\ {F}_{A} ( α , V ) = CA ( α ) qbarSref & ( 5 ) \\ {F}_{N} ( α , V ) = CN ( α ) qbarSref & ( 6 ) \\ M ( α , V ) = CLMCG ( α ) qbarSrefLref & ( 7 ) \\ qbar = \frac{1}{2} ρ \sqrt{{V}_{x}^{2} + {V}_{z}^{2}} & ( 8 ) \\ α = θ - arctan ( \frac{- {V}_{x}}{{V}_{z}} ) & ( 9 )\end{matrix}$$

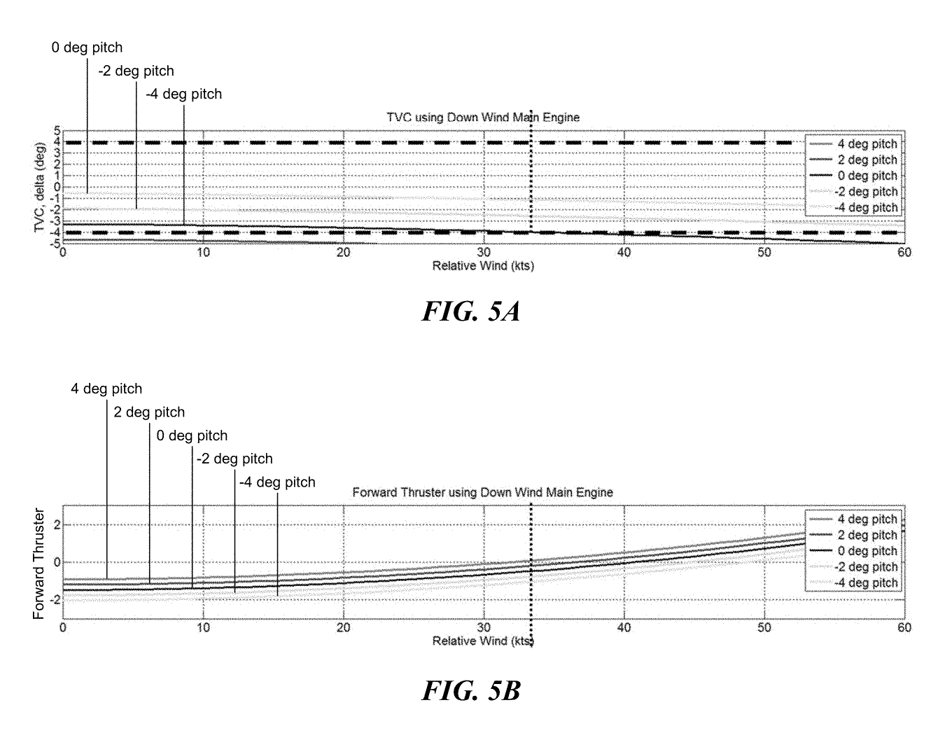

The analysis below is based on relative wind, which includes environmental winds and inertial velocity. FIG. 3, based on simple geometry and constant speed, is included to aid the reader in mapping relative wind capability (expressed in knots) as a function of position error correction capability (expressed in feet), to demonstrate the benefits of approaching the landing platform from up-wind.

2.2 Discussion of the Benefits of Laterally-Directed Thrusters during Landing

The addition of one or more laterally-directed thrusters to the forward end of the vehicle is expected to allow for (a) trimmed vertical landing in crosswinds and/or (b) tighter positional control during landing, compared to a similar vehicle that does not include such thrusters. A vehicle that does not include laterally-directed thrusters typically translates and maneuvers against relative headwinds by using gimballed axial engines and/or the TVC capability of the main engines to tilt (or counter a wind force pushing the vehicle to tilt) or point the vehicle. Then, once pointed, the TVC is generally aligned with the vehicle center of gravity (except for what is needed to counter a pitching moment) resulting in an acceleration vector aligned with the vehicle body. Conceptually, such a vehicle uses a combination of axial engine thrust and TVC to point the vehicle, and axial engine thrust and vehicle attitude is used to control lateral and vertical speed.

By contrast, the subject vehicle of the present analysis has laterally-directed thrusters, which provide an extra control effector to provide side forces and pitching torque. This benefits the vehicle in one or both of at least two respects: first, the vehicle can trim the forces and moments associated with relative side wind (due to translational speed, or environmental winds) to a specific (but limited) pitch angle to assure that it can land at the appropriate attitude while maintaining position control. Second, lateral dispersions and disturbances can be mitigated through a direct side force (using combined main engine TVC and laterally-directed thruster(s) to create the side force while balancing the pitching moment) without requiring re-pointing the vehicle body. This is expected to provide tighter and timelier control responses to disturbances and lateral offsets, and improve (e.g., maximize) landing control precision.

### 2.3 Limiting Vehicle Characteristics

The pitching moment due to side winds is due to the low center of gravity with respect to the center of pressure. A booster vehicle is typically very stable about the negative body X-axis. As a result, it often creates pitching forces when translating during the T=W portion of landing (e.g., with descent velocity Vx=−7 ft/s) and when hit by a significant side wind. This pitching moment is to be overcome through use of TVC and laterally-directed thrusters so as to maintain control of the vehicle. In particular, the combined TVC force and laterally-directed thruster force, in the z-direction, are to overcome side force (from CN_Wind) due to translation and winds.

### 2.4 Analytical Results

### 2.41 Trim Condition at Landing (Fixed Pitch)

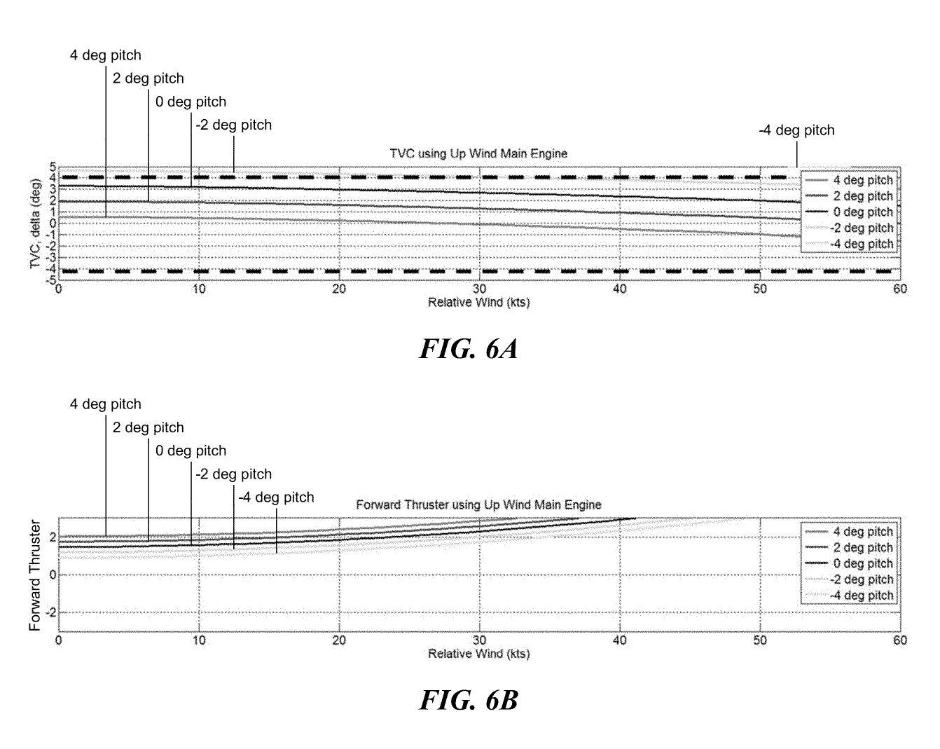

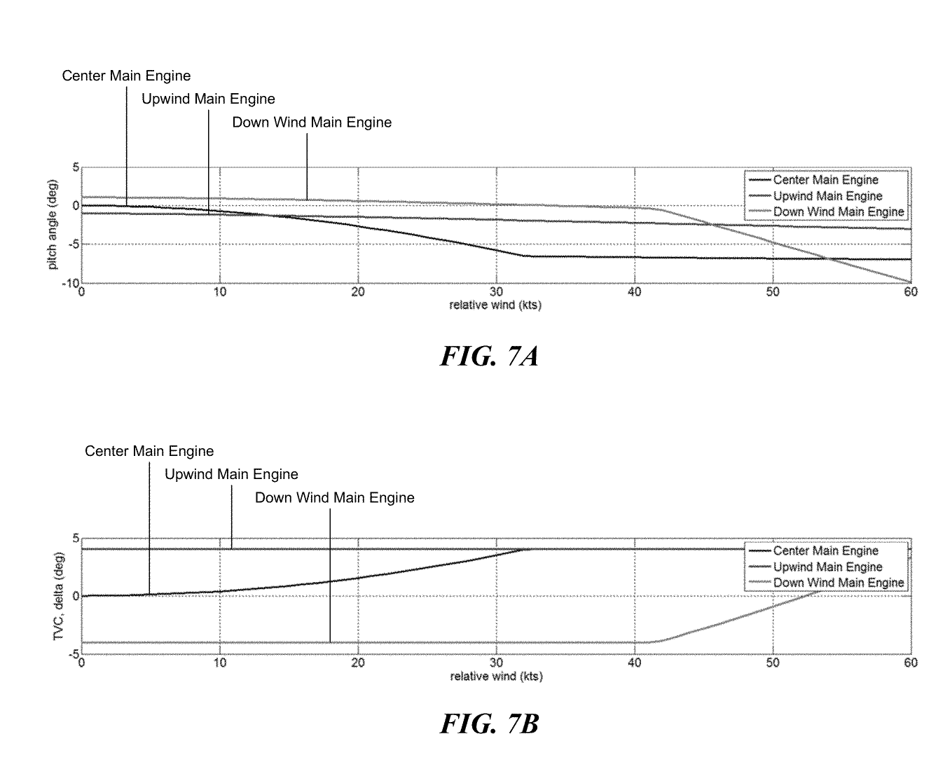

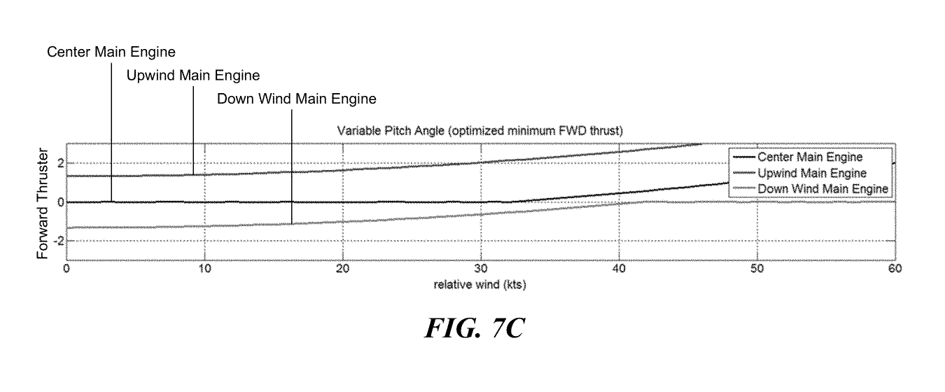

At landing, it may be necessary to trim the vehicle against a steady wind at a pitch angle that matches the landing platform deck angle (which is zero for a stabilized landing platform). A nonlinear optimizer was used (with the above nonlinear aerodynamic model to determine the required laterally-directed thruster forces and TVC angle to trim the vehicle against a constant relative side wind (−Vz direction) at specific pitch angles. FIGS. 4A-4B show results with the center main engine (only) operating, FIGS. 5A-5B show results with the down-wind main engine (only) operating, and FIGS. 6A-6B show results with the up-wind main engine (only) operating. The thrust values on the vertical axes of these and other Figures in the present application are scaled relative to a fixed base value.

FIGS. 4A and 4B illustrate that the modeled configuration can trim against relative winds up to 47 knots at various pitch angles up to +/−4 deg (as indicated by a dashed vertical line) using the center engine (FIG. 4A) and laterally-directed thrusters (FIG. 4B). As such, landing platform pitch/roll requirements can be relaxed an additional 4 degrees by using a suitable method to predict deck attitude and motion during landing. This upper limit on the relative wind will typically mandate that winds be considered and accommodated through changing the landing trajectory to approach the platform from up-wind (as opposed to straight down or down-wind) at higher wind-speed conditions.

FIGS. 5A-5B and FIGS. 6A-6B illustrate results for a vehicle that can only trim to a pitch range of less than +/−1 degree before saturating the TVC angle, even with no relative wind, when the center main engine is not available. FIGS. 5A-5B show that when using only an off-center main engine, the zero pitch trim condition requires greater than −3 degrees TVC at zero relative wind; however, the upper bound on relative head wind, against which it can trim at zero pitch angle, is reduced from 47 knots (FIGS. 4A-4B) to 36 knots (dotted vertical line). FIGS. 6A-6B show that using only the up-wind off center main engine requires more than 3 degrees TVC even at zero wind.

### 2.42 Trim at Optimum Pitch Angle to Reduce Laterally-Directed Thruster Requirement

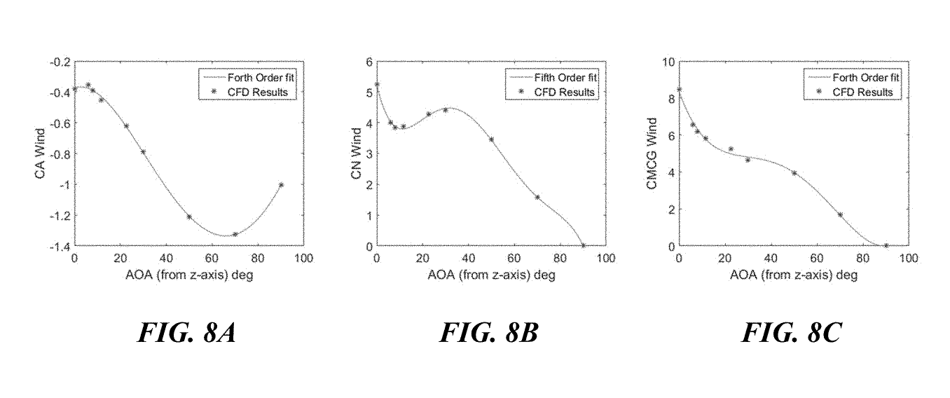

The foregoing trim analysis was then repeated without a constraint on vehicle pitch angle. This analysis examines the T=W period prior to the final landing phase during which the vehicle pitch angle can be used to aid in maneuvering. The TVC angle in this case is again constrained to +/−4 degrees. This analysis was completed for the following conditions: firing only the center main engine, firing only the up-wind main engine, and firing only the down-wind main engine condition. The results are shown in FIGS. 7A-7C. In the center main engine case, it can be seen that the example vehicle can trim against a relative wind of 32 knots without requiring any laterally-directed thrusters at all, provided the vehicle is pitched to −7 degrees. Above 32 knots, the TVC trim authority is depleted (e.g., at a maximum of 4 degrees) and the laterally-directed thruster is needed to balance that additional relative wind-induced pitching moment.

When using only the up-wind main engine, laterally-directed thrust and a full 4 degrees of main engine TVC is needed to trim the vehicle even at zero relative wind speed, with the vehicle pitched to −1.7 deg. As forward relative speed increases, a greater force from the laterally-directed thruster is needed.

When using only the down-wind main engine and full −4 degree TVC, laterally-directed thrust (in the opposite direction of the above case) is needed to trim the vehicle even at zero relative wind and 1.7 degree pitch angle. As the relative wind increases, less force from the laterally-directed thruster is needed until a wind speed of approximately 42 knots, at which point none is needed and trim is maintained with TVC and pitch angle alone.

2.5 Conclusions from First Simulations
In particular embodiments, some portion of TVC authority can be reserved for control (e.g., trim range is +/−4 degrees).
If the landing strategy biases the trajectory to the up-wind side of the landing platform, the cross-range capability in high wind conditions can be improved (e.g., maximized).
In particular embodiments, acceptable landing wind conditions are limited to the maximum trim-able speed needed to match the landing deck angle requirements.
The ability of the vehicle to trim vertically for landing in a crosswind, using only an outer main engine (e.g., if the center engine fails), is reduced when using the down-wind engine. This issue can be avoided by rolling the vehicle to align the available outer main engine to be up-wind, rather than down-wind.

### 3.0 Second Simulations

A more detailed 6DOF nonlinear, static trim model was developed and used to analyze the baseline configuration (with 12 laterally-directed thrusters, as shown in FIGS. 1A-1E) and trim conditions when using an outboard main engine, not aligned with the relative wind. This model was used to analyze the trim-ability of the vehicle configuration in varying relative winds, with center, up-wind, and down-wind main engine, when the vehicle is commanded to zero pitch attitude and when it is free to find an optimal attitude. Specific test cases were analyzed, and included limited TVC range, limited laterally-directed thruster authority ranges, and specific laterally-directed thruster failures to determine appropriate trim responses.

### 3.1 Assumptions Regarding 3DOF Analysis

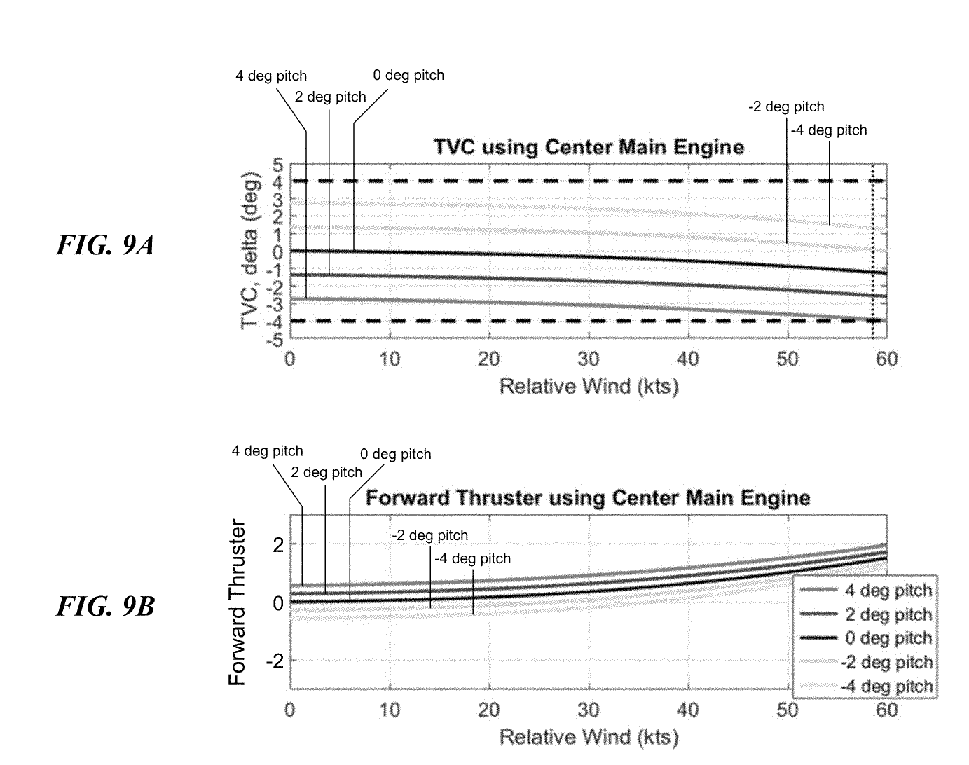

For the purpose of developing an approximate aerodynamic model, aerodynamic coefficients were fit to fourth and fifth order polynomial curves (FIGS. 8A-8C) for simplification. A change of reference angle of attack (AOA) was used to aid curve fitting. This new reference uses AOA defined as the angle between the relative wind vector and the vehicle positive Z axis (called αₒ). It should be noted that the normal vehicle AOA is defined as the angle between relative wind and the vehicle positive X axis (called α). The (3DOF) model and equations which must be balanced to achieve trim and basic vehicle model were discussed above under Heading 2.0.

3.2 DOF Analysis with New Configuration

### 3.21 Trim Condition at Landing (Fixed Pitch)

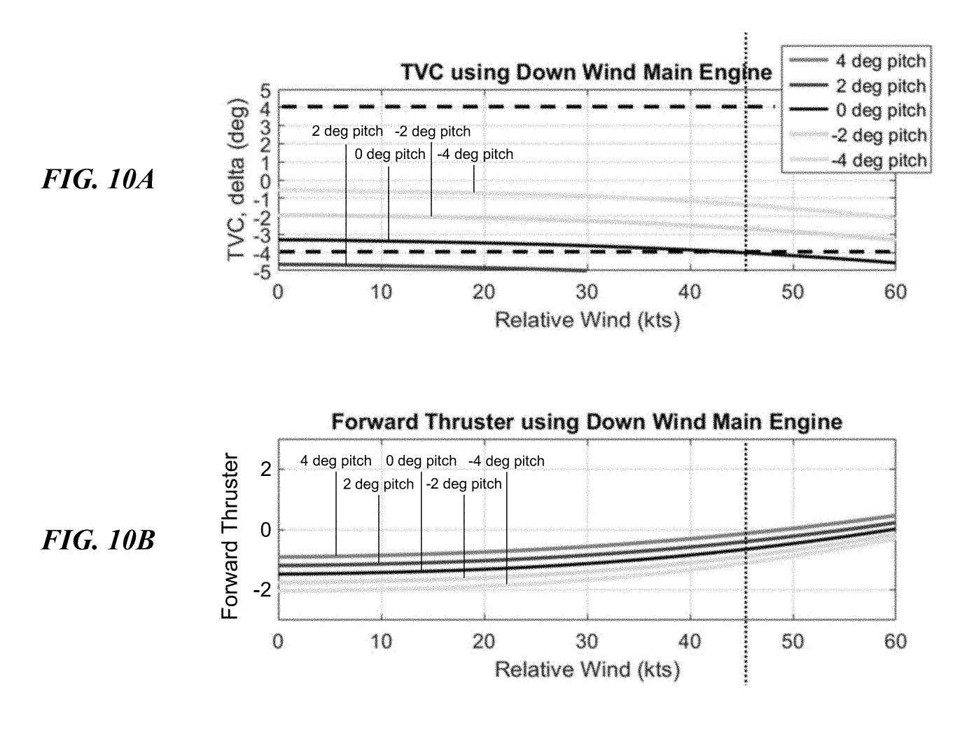

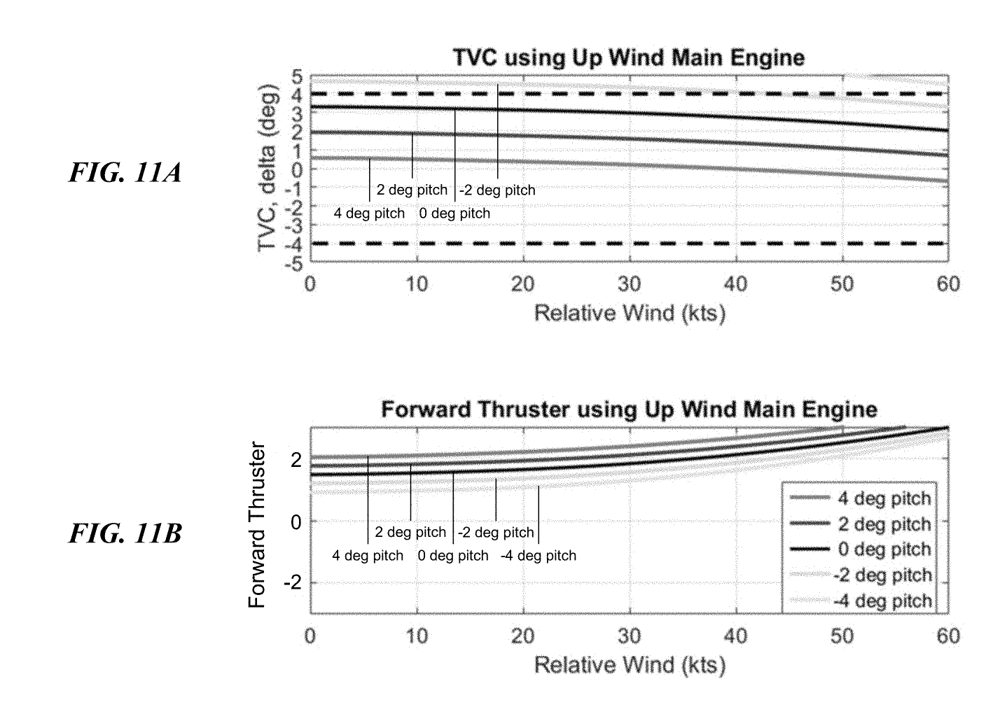

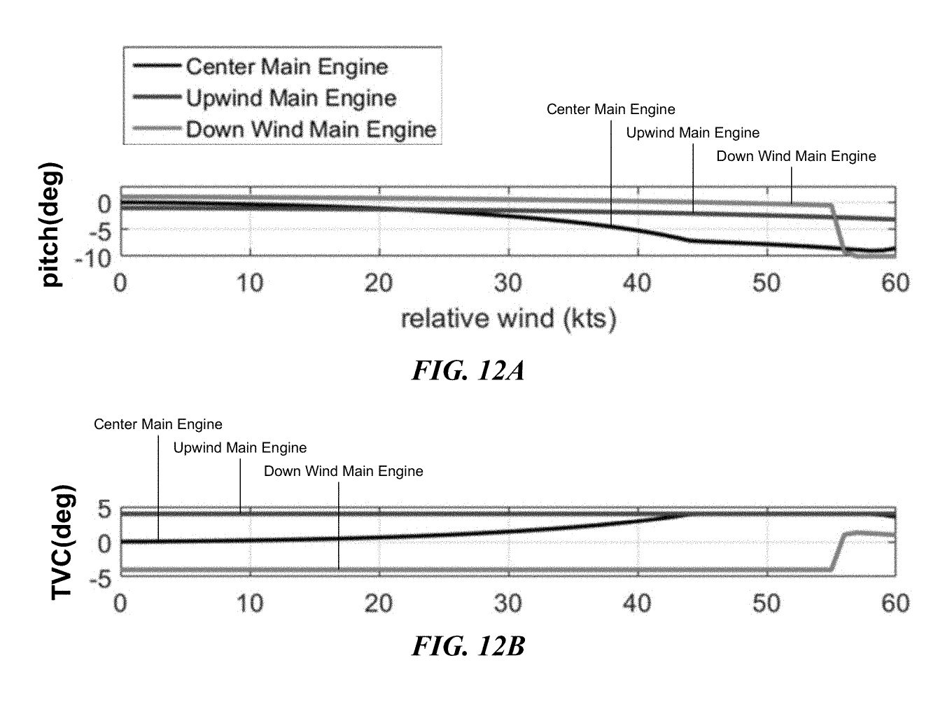

To reduce gear loads during landing in accordance with at least one embodiment, the vehicle is trimmed against a steady wind at a pitch angle that matches the landing platform deck angle (which is zero for a stabilized landing platform). FIGS. 9A-9B illustrate representative results when the center main engine is used, FIGS. 10A-10B illustrate representative results when the down-wind main engine is used, and FIGS. 11A-11B illustrate representative results when the up-wind main engine is used. Each of the foregoing Figures are then used to determine what fixed pitch angles can be trimmed.

FIGS. 9A-9B demonstrate that the modeled configuration can trim against relative winds up to 59 knots at vehicle pitch angles up to +/−4 deg (see dashed vertical line in FIG. 9A) using the main center engine and laterally-directed thrusters. As such, landing platform pitch/roll requirements could be relaxed an additional +/−4 degrees if a suitable deck attitude and motion prediction is developed and used during landing. This represents an improvement of 12 additional knots of relative wind capability compared to the results shown in FIGS. 4A and 4B by using a laterally-directed thruster on the vehicle.

FIGS. 10A-10B and FIGS. 11A-11B demonstrate that the vehicle can only be trimmed to a pitch range of less than +/−1 degree without saturating the TVC angle even with no relative wind. FIGS. 10A-10B show that when using only the down-wind outboard main engine, the zero pitch trim condition requires greater than −3 degrees TVC at zero relative wind; however, the upper bound on relative head wind, against which it can trim even at zero pitch angle, is 46 knots (dotted vertical line). This upper limit on relative wind will mandate that winds be considered and accommodated by changing the landing trajectory to approach the platform from up-wind, at higher wind conditions. FIGS. 11A-11B show that using only the up-wind outboard main engine requires more than 3 degrees TVC even at zero wind. Both these cases tend to align the engine TVC angle toward the vehicle CG and then use the laterally-directed thruster to offset the resultant side force.

### 3.22 Trim Analysis of 3DOF at Optimum Pitch Angle to Reduce Laterally-Directed Thruster Requirement

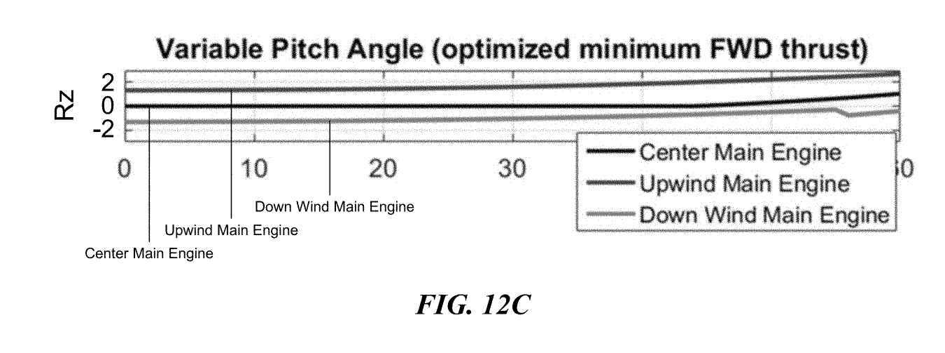

The foregoing trim analysis was then repeated without a constraint on the vehicle pitch angle. This analysis examines the T=W period prior to the final landing phase during which the vehicle pitch angle can be used to aid maneuvering. The TVC angle in this case is again constrained to +/−4 degrees. This analysis was completed for the center main engine condition, the up-wind main engine condition and the down-wind main engine condition. The resulting curves are shown in FIGS. 12A-12C. In the center main engine case it can be seen that the vehicle can trim against a relative wind of 43 knots without requiring any laterally-directed thruster at all, provided the vehicle is pitched to −7 degrees. Above 43 knots, the TVC trim authority is depleted (e.g., at a maximum of 4 degrees) and the laterally-directed thruster is needed to balance the additional relative wind induced pitching moment.

When using only the up-wind main engine, thrust and some TVC is needed to trim the vehicle even at zero relative wind speed, with the vehicle pitched to −1.7 degrees.

When using only the down-wind main engine and full −4 degree TVC, laterally-directed thrust (in the opposite direction of the above case) is needed to trim the vehicle even at zero relative wind and 1.7 degree pitch angle. As the relative wind increases, less force from the laterally-directed thruster is needed until about 55 knots at which point the optimal solution switches from a slightly pitched up angle to a −10 degree pitch angle (the limit used in optimization).

3.23 DOF Trim Test Cases using Baseline 12-Thruster Configuration

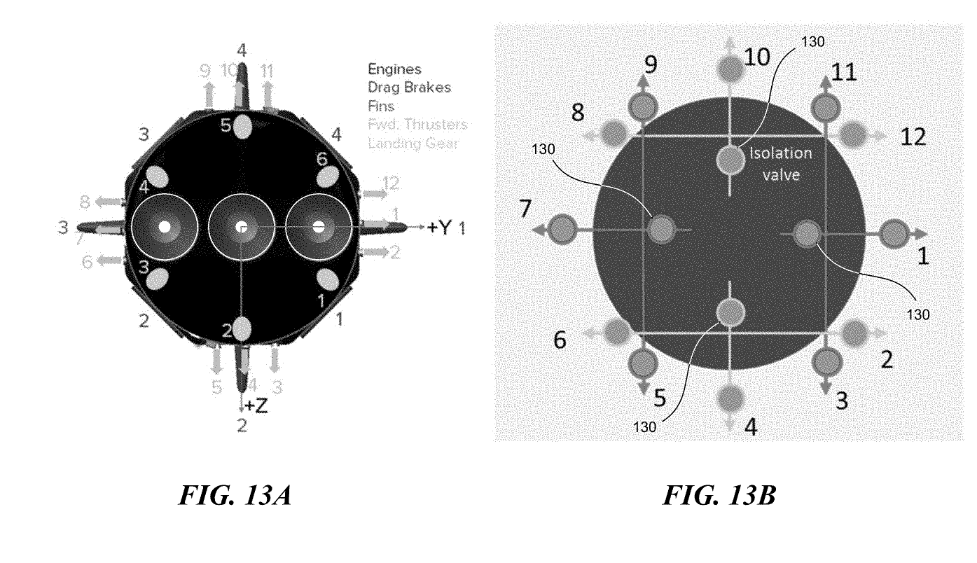

The baseline laterally-directed thruster and main engine configuration is shown in FIGS. 13A-13B. Each of the laterally-directed thrusters (numbered 1-12) is assumed to be linearly controlled over a limited range. Each laterally-directed thruster can also be turned off. The configuration can also include isolation valves 130 (FIG. 13B) which can be used to close off the propellant flow to three laterally-directed thrusters to prevent propellant loss if a laterally-directed thruster becomes stuck in the open position. Nominally, this configuration can generate suitable thrust in the Y and Z axis directions.

To analyze this configuration, including its robustness to thruster failures, a full 6DOF static force balance model was developed using Mathematica (available from Wolfram Research of Champagne, Ill.). The model included the main engines (using only one for each test case) and 12 laterally-directed thrusters. A nonlinear optimizer was used to trim the vehicle against the aerodynamic forces and torques from a relative wind coming from the body y direction (creating a positive z axis yawing moment), derived from the 3DOF model described under Heading 2.0 and the aerodynamic curve fits described above, during the terminal portion of the landing operation (for which T=W, Vx=−7 ft/s). The nonlinear optimizer was used to find the needed pitch angle, TVC angles, main engine thrust and laterally-directed thruster commands needed to generate appropriate forces and torques to trim the vehicle. Various specific cases were analyzed to determine if the configuration (including given limitations) can trim against apparent winds of 0, 20, 40, and 60 knots. Cases include both requiring the tilt angle to be zero (needed for touchdown on a fixed horizontal platform) and allowing the vehicle tilt angles to be optimized to minimize laterally-directed thruster requirements. The cases include using only the center engine, only the up-wind engine, and only the down-wind engine. Also included were cases which utilized the center engine, but have a failed bank of laterally-directed thrusters (which can be chosen to be the most difficult, coupled case).

For the purposes of analysis, two representative configurations were analyzed: (1) with the laterally-directed thrusters each throttle-able, and (2) with the laterally-directed thrusters either off or throttle-able at a higher range. The second configuration (with a higher range for thrust or fully off) has an optimization space with up to (2¹²−1) local minima.

### 3.3 Discussion of 6DOF Trim Test Cases

Various test cases were run (assuming t laterally-directed thrusters that throttle linearly down to zero lb-f thrust). Cases include both (1) requiring the tilt angle to be zero (pitch=0), as required for touchdown on a fixed horizontal platform and (2) allowing the vehicle tilt angle to be optimized to minimize laterally-directed thruster requirements while providing maximal cross-range speed or trimming against cross winds. The cases include using only the center engine, only an up-wind engine, and only a down-wind engine.

The results utilizing the full 6DOF model with center engine operational but with the pitch angle constrained were consistent with the results from the simpler 3DOF analysis discussed earlier and show the baseline 12 laterally-directed thruster case can trim the vehicle in a wide range of relative winds. Additional cases demonstrated that when the vehicle pitch angle is not constrained but is optimized, less laterally-directed thrust is needed.

Differing from the baseline, the TVC gimbals were modeled as two perpendicular axis gimbals (about the y and z body axis) each constrained to a range of +/ −4 degrees. For this analysis the simple two axis rotations are assumed, to eliminate optimizer convergence issues.

Several cases utilized the center engine, but simulated a failed bank of laterally-directed thrusters (thrusters 2, 4, and 6) to demonstrate the configuration's robustness to laterally-directed thruster failures.

3.4 Conclusions from Second Simulations
Based on the foregoing static analysis, using the center main engine, in low to moderate winds, is relatively straight forward. High wind cases and outboard main engine landings couple the control degrees of freedom (attitude and translational) and require an integrated control allocation solution to balance vehicle rotational torques and translational forces using multiple (e.g., all) control effectors. This differs from existing control approaches which control vehicle attitude extensively with TVC during landing and thrust for vertical velocity control.
For the representative configuration described herein, trimmed vertical landing at fixed non-zero deck angles, when operating with only an outboard main engine is limited. Orienting the vehicle to align the outboard main engine, in an up-wind direction provides the greatest zero pitch angle trim ability against relative winds.
The 12 laterally-directed thruster configuration, with only the center main engine operating, is capable of trimming the vehicle during landing, even with a failed bank of (3) laterally-directed thrusters.
Methods to implement and efficient control allocation mixer in real time are described further under Heading 4.0.
Precision landing of the vehicle, in multiple wind conditions, is desirable to provide high robustness and system availability. Tight vehicle attitude control (e.g., to reduce or minimize landing gear requirements) during landing in high winds, and tolerance to center main engine failure, couple the vehicle degrees of freedom, which drives the need for a laterally-directed thruster and an integrated control scheme, which generate actuator commands to control multiple (e.g., all) degrees of freedom in a coordinated manner. The foregoing analysis demonstrates that capability. A laterally-directed thruster concept using many smaller on/off laterally-directed thrusters may, for example, provide weight and cost benefits, as discussed under Heading 4.0 below.

### 4.0 Third Simulations

This section discusses a representative control mixer to generate TVC, main engine thrust, and commands for candidate laterally-directed thruster arrangements for use during precision landing. Two basic laterally-directed thruster arrangements are described. The first includes 12 linear thrusters with a dead band, and the second includes many (in particular, 48) smaller on/off (“binary”) thrusters.

This control mixer arrangement was developed for three specific laterally-directed thruster configurations. The first configuration includes 12 “linear” thrusters, each capable of throttling linearly down to zero thrust. The second configuration includes the same 12 thrusters, with the thrust ranges of each restricted to be zero or some higher-range of thrust, but not linearly throttlable between the minimum thrust and zero thrust. The third configuration includes 48 on/off “binary” thrusters.

A quasi-6DOF simulation was developed in Simulink (available from Mathworks of Natick, Mass.) to validate and demonstrate the control mixer behavior against a protracted test case which commands small, but rapid, translational maneuvers and trims against increasing side (relative) wind disturbances of 0-60 knots.

### 4.1 Assumptions

The vehicle configuration and mass properties are those discussed above under Heading 2.0, and the aerodynamics effects model is the same as that described above under Heading 3.0. It should be noted that the following analysis assumes laterally-directed thruster and forward fin layouts aligned with the vehicle y and z body axis. In other embodiments, the laterally-directed thrusters and fins are rotated 45 degrees in the body y-z frame. This change will alter the specific results of the simulated responses but not the overall conclusions or mixer characteristics.

### 4.2 First Embodiment—12-Thruster Configuration

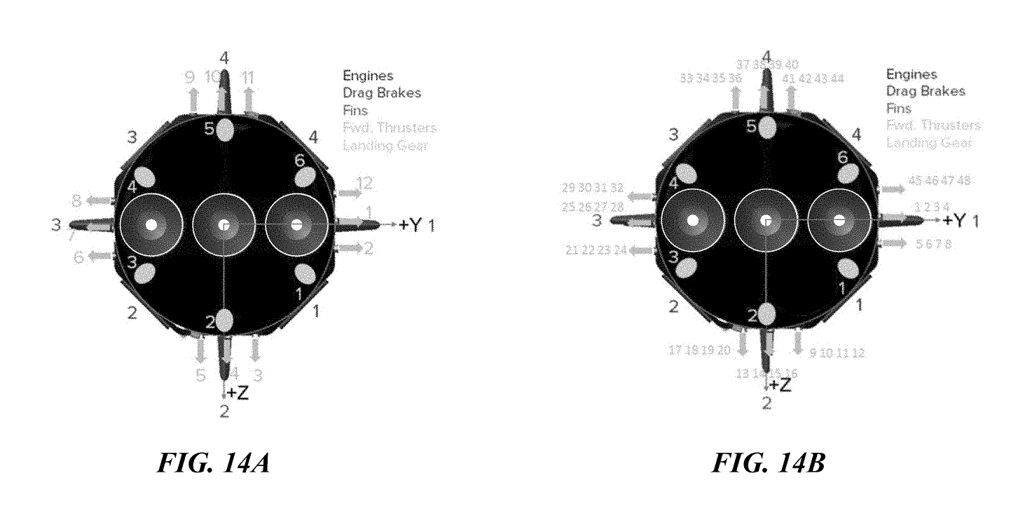

A first embodiment of the laterally-directed thruster and main engine configuration is shown in FIG. 14A, and is the same as the configuration shown in FIG. 13A. Static control allocation trim solutions were developed for this configuration, as discussed above under Heading 3.0. This section describes a dynamic, optimization-based control allocation mixer that solves the optimization problem discussed under Heading 3.0 in real time. This mixer was first demonstrated assuming the 12 laterally-directed thrusters are linear and then linear with a dead band.

### 4.3 Second Embodiment—48 Binary Thruster Configuration

A second embodiment of the laterally-directed thruster configuration using 48 binary thrusters is shown in FIG. 14B. In this configuration, each of the individual throttling laterally-directed thrusters in the 12 thruster configuration is replaced with 4 smaller thrusters oriented in the same direction, and offset from each other in the body x axis and cross axis (from the pointing direction). It is assumed that these laterally-directed thrusters can only be operated in an on/off “binary” manner, and therefore, pulse trains are used to vary the resultant control forces (which are integrated over time).

One advantage of this configuration is that in the event of a single laterally-directed thruster failure, the available force is reduced by only the force of one small thruster. Additionally, other potential faults, such as a thruster valve stuck open, can be accommodated by countering the adverse disturbance effect of one such a thruster with another thruster, and absorbing the (relatively small) resulting propellant loss.

Such a configuration, although more complex, may in fact be lower cost and/or provide greater resistance to failure, and/or improve control performance by using higher bandwidth thrusters. The number, size, location and orientation of these “many” thrusters can be selected in a manner that depends on suitable variables, including the overall configuration of the rocket system.

Due to the binary nature of the valves in this configuration, it will generally not operate in a true steady state trim condition. Instead, the valves can be dithered on and off to operate about (e.g., near) the desired trim condition. As such, a dynamic model may be required to reach a quasi-steady state corresponding to the trim state.

### 4.4 The Control Mixer Problem

The control allocation problem for highly coupled systems, such as the vehicle in high cross winds, and/or landing on an outboard main engine, is a non-trivial problem. Several methods have been historically applied to such problems. One possible solution is to “invert” the control effectiveness matrix to generate all six needed forces and torques using all available control effectors, but constrain the resultant control commands to be achievable (for instance, TVC commands must be within limits, thrusts must always be positive, etc.). For systems that have a greater number of control effectors than desired control degrees of freedom, the control effectiveness matrix is not square (the system is overdetermined). For such systems a pseudo-inverse approach can be used to generate a set of control commands which, theoretically, achieve the desired accelerations in all 6DOF. More often, this solution must be altered by adding additional control command vectors in the null space of the control effectiveness matrix (combinations of pulses that provide little or no net accelerations, due to the effectors fighting or off-setting each other) in order to command all controls to be within achievable limits (e.g., TVC commands within limits, only positive thrust commands, etc.)

### 4.5 Control Allocation Mixer Block Diagram and Quasi-6DOF Simulation

The optimizing mixer presented herein is a fundamentally different approach to solving the control allocation problem. It uses a numerical feedback loop (containing no actual physical dynamic elements) to solve the inverse problem within the actuator constraints. This formulation also allows integrated control command generation for differing types of control effectors, such as linear TVC and on/off laterally-directed thrusters. An explanation of this approach follows.

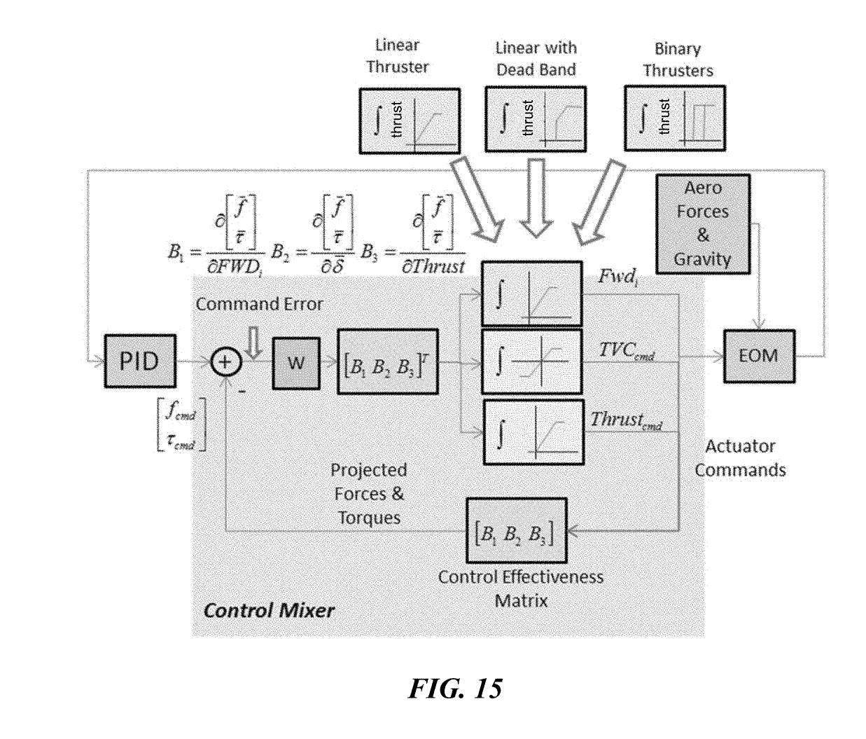

Assuming that the control effectors are linear, and looking only at the control allocation mixer by itself in FIG. 15, void of plant model and outer loop proportional, integral and derivative (PID) controller, this control mixer uses an internal model of the relationship between actuator commands and projected accelerations and angular accelerations (represented in the block diagram as the “B-matrix”) to generate predicted accelerations. The predicted accelerations are subtracted from the desired accelerations and the resultant error mapped from acceleration space back to actuator space (via B^{T}W) and integrated. This feedback loop drives the error between projected and desired acceleration to zero with exponential convergence.

The positive definite (having only real positive eigenvalues) 6×6 weighting matrix W can be chosen to provide rapid convergence at a rate much greater than the bandwidth of the system to be controlled, to reduce (e.g., minimize) the interaction between the control mixer and the vehicle. In a representative embodiment, a diagonal matrix is used, with each element weighting the importance of each of the six controlled degrees of freedom, relative to the others.

The eigenvalues of the closed loop feedback matrix (−WBB^{T}) are always negative real (it is negative definite), guaranteeing global exponential convergence. The control mixer loop is purely a mathematical loop, containing no physical elements. As such, in a continuous system, the effective loop gain could be made arbitrarily high, forcing convergence to occur very rapidly. However, implementation issues (due to discrete implementation) limit the feedback gain. Instead, the weighting matrix W can be chosen to place the closed loop eigenvalues of feedback matrix (−WBB^{T}) to be (a) significantly (e.g., at least three times) faster than the rigid body dynamics of the vehicle to mitigate interaction with the vehicle being controlled, but (b) low enough to be implemented in a sampled data system with a reasonable frame rate. This control mixer arrangement, assuming linear control effectors, can be shown to converge to the pseudo-inverse of the weighted control effectiveness matrix (\sqrt{W}B).

If we introduce monotonic, nonlinear elements in the feedback loop, such as TVC limits (+/−5 degrees), main engine limits (20%-100% of thrust) and laterally-directed thruster limits, this feedback loop still maintains exponential convergence, as long as a solution is feasible within the limits. During convergence, if a control limit is reached, the control command “rides” that limitation until the solution is reached, if one exists, or converges to the nearest (in a weighted 2-norm sense) solution which is bound by the actuator limits. This concept was applied to the 12-linear thruster configuration.

If we introduce more complex, monotonic nonlinearities, such as dead-bands in the control mixer feedback loop, we can solve for the control mixer case where the force provided by the laterally-directed thrusters is zero or covers a range. This is accomplished by creating a limitation element which contains a dead band or “keep out zone” of thrust for each laterally-directed thruster in the control mixer feedback path. Due to this dead band, exponential convergence cannot be universally guaranteed if the minimal solution lays in the actuator dead bands. However, this loop can be shown to be Lipschitz stable, i.e. converging to a small region about the solution. Given a solution within the dead band of the control effectors, the mixer can generate commands that dither in and out of the dead band, creating modulated pulse commands with integrated area (with respect to time) equivalent to the needed control effect. For small required commands, this system acts as a pulse (both frequency and pulse width) modulator. This approach can, for example, be applied to the 12-linear thruster with dead band configuration.

Finally, if we assume only laterally-directed thrusters which are binary (on/off), the monotonic nonlinearity can be replaced with a monotonic hysteresis. Such a mixer generates pulse commands which, on average, generate the needed forces. Again, this loop can be shown to be Lipschitz stable about the optimal control allocation. This approach can, for example, be applied to the 48 binary thruster configurations.

For all of the foregoing configurations, the TVC and Main engine thrust commands were treated as linear but limited (+/−5 degrees for the TVC and 20%-100% for the main engine).

### 4.6 Discussion of Analysis Cases

A quasi-6DOF model was developed in MATLAB/Simulink to test and demonstrate the foregoing arrangements. The simplified model, shown in FIG. 15, contains 6DOF inertial equations of motion and a PID controller which can be used to generate vehicle attitude and position commands, the control mixer and simple disturbances to act as surrogate gravity and aerodynamic effects. To demonstrate the mixer arrangement, the vehicle is commanded to hover (T=W) and to translate a few (e.g., 5 and 10) feet in the y and z directions, with the surrogate wind effect ramping from 0-60 knots of wind after 10 seconds.

In this simulation, the only external forces acting on the vehicle are gravity and a simple aerodynamic disturbance (pitching, axial, and normal forces). This simplified model does not couple the vehicle movement with aerodynamic forces but instead approximates aerodynamic forces as a pure disturbance. This aerodynamic disturbance can be derived from the nonlinear curve fit aerodynamic model described under Heading 3.0. In this simulation, the vehicle is in a vertical flow field of −7 ft/s (a representative landing speed). The test case in which the vehicle hovers (i.e., maintains vertical position) in this flow field is expected to be representative of the landing phase, while mitigating the shortcomings of the quasi-6DOF simulation (e.g., due to the aerodynamics not being coupled with vehicle movements). To simplify the illustration, this quasi-6DOF also lacks detailed actuator dynamics, sensor dynamics, system lags, slosh dynamics, “tail-wags-dog” effects, flexible body effects and parameter uncertainties. However, the model is designed to demonstrate (in an approximate manner) the control mixer behavior that would be associated with a more complex simulation.

The test simulations were run for the three laterally-directed thruster configurations described above, using only a main center engine, only an outboard up-wind main engine, and only an outboard down-wind main engine. The down-wind cases are not presented here for purposes of brevity, but are similar to the up-wind cases.

The control mixer arrangement described above can command, for example, the 12-thruster (linear) and 12-thruster (linear with dead band) configurations, in combination with TVC and main engine thrust, to control the vehicle in simple maneuvers and against representative wind disturbances. It can also perform that task when subject to the coupled dynamics associated with using an outboard main engine.

The control mixer can also be used to command many on/off thrusters, alone or in combination with TVC and engine thrust commands, to accomplish the same maneuvers. Such a configuration, although utilizing many more thrusters, may have benefits over the linear thruster arrangements. In particular the actuation valves may be much simpler and lower cost. Additionally, potentially complex isolation plumbing (described above with reference to FIG. 13B) may be eliminated, if the system (and propellant) can be sized such that the failure of a single thruster (open or closed) can be mitigated with the remaining thrusters. In addition, smaller, higher bandwidth thruster valves can provide tighter control than larger linear thruster control valves.

In another embodiment, some of the high bandwidth thrusters can be configured to provide a thrust contribution along the vehicle x-axis. As a result, such thrusters can be used (in combination with the main engine thrust) to provide a high bandwidth “Vernier” control in the vertical direction. This, combined with precision navigation, and deck motion prediction, can allow precise deck motion compensation on landing. Also, tight vertical speed control can allow non-vertical flight path angles at final approach and landing, which can facilitate a wider range of landing and capture configurations.

### 5.0 Further Embodiments

An aerospace system in accordance with some embodiments of the present technology includes a launch vehicle having a first end and a second end generally opposite the first end, with the launch vehicle being elongated along a vehicle axis extending between the first end and the second end. A propulsion system is carried by the launch vehicle and has at least one main engine with a corresponding nozzle positioned toward the first end of the launch vehicle to launch the launch vehicle. At least one laterally-directed thruster is positioned toward the second end of the launch vehicle, and the system further includes a controller in communication with the launch vehicle. The controller is programmed with instructions that, when executed, direct the launch vehicle in a first direction during vehicle assent, direct the launch vehicle in a second direction, opposite the first direction, during vehicle descent, and direct activation of the at least one laterally-directed thruster to guide the launch vehicle during descent.

In further particular embodiments, the at least one laterally-directed thruster is one of multiple such thrusters. Individual thrusters can have corresponding nozzles with corresponding nozzle exits that are co-planar. Individual thrusters can be directed in four different directions, and the system can include multiple thrusters (e.g., three) pointed in the same direction. Individual laterally-directed thrusters can be positioned to direct thrust with a lateral component relative to the vehicle axis and in particular embodiments, with a non-lateral component. The laterally-directed thrusters can be controllable among multiple non-zero thrust settings or a binary set of thrust settings (off and on). The controller can be programmed with instructions that direct the launch vehicle to translate laterally under a force provided by the at least one laterally-directed thruster, in combination with a force provided by the at least one main engine. The at least one main engine can include a center main engine and an off-center main engine, and the controller can direct the launch vehicle to descend under power provided by the off-center main engine (e.g., only the off-center main engine) and the at least one laterally-directed thruster. The controller can direct the at least one laterally-directed thruster to control an orientation of the launch vehicle after the launch vehicle has landed, and/or in response to an external force (e.g., a wind force) applied to the launch vehicle. In some embodiments, the controller can respond to an input corresponding to a tilt angle of a landing site toward which the launch vehicle is travelling, and direct the at least one laterally-directed thruster to control an orientation of the launch vehicle at least in part in response to that input. The at least one laterally-directed thruster, in combination with the at least one main engine, can propel the launch vehicle in a direction having a lateral component, and in particular embodiments, in a lateral direction. The launch vehicle can be a single stage vehicle, or a multi stage vehicle.

An aerospace system in accordance with some embodiments of the present technology includes a controller operatively coupleable to a launch vehicle and programmed with instructions that, when executed, direct the launch vehicle in a first direction during vehicle ascent via thrust from one or more main engines, direct the launch vehicle in second direction, opposite the first direction, during vehicle descent, and direct activation of at least one laterally-directed thruster and at least one of the one or more main engines to move the launch vehicle laterally during descent. The at least one laterally-directed thruster is spaced apart from the at least one main engine along a longitudinal vehicle axis of the launch vehicle. When a first one of the one or more main engines is inactive during descent, the instructions can direct activation of a second one of the one or more engines. The instructions can direct activation of the at least one laterally-directed thruster and the at least one of the one or more main engines in response to varying wind loads on the launch vehicle.

A representative method for operating an aerospace system includes launching a launch vehicle using thrust from one or more main engines positioned toward the first end of the launch vehicle, directing the launch vehicle to descend, and controlling the descent of the launch vehicle via (a) at least one of the one or more main engines, and (b) at least one laterally-directed thruster. The at least one laterally-directed thruster is spaced apart from the at least one main engine along a longitudinal axis of the launch vehicle. The method can further include directing the launch vehicle to land with a corresponding nozzle of the at least one main engine facing downward. In a further particular embodiment, launching the vehicle is performed using at least a first one of the one or more main engines, and controlling descent of the launch vehicle performed using a second (e.g., only a second) of the one or more main engines, and not the first. Controlling the descent of the launch vehicle can include moving the launch vehicle laterally while an attitude of the launch vehicle remains generally the same, e.g., within plus or minus two degrees of the initial attitude, or a target attitude.

From the foregoing, it will be appreciated that specific embodiments of the disclosed technology have been described herein for purposes of illustration, but that various modifications may be made without deviating from the technology. For example representative launch vehicles can have configurations different than those specifically shown and described herein. The main engines can have different configurations and/or thrust vectoring capabilities than those specifically described above. The laterally-directed thrusters can have different configurations, thrust capabilities, and/or other characteristics (e.g., a fixed position or pivoting configuration) depending on the application. The simulations described herein can be conducted in accordance with other assumptions and methodologies in other embodiments. Certain aspects of the technology described in the context of particular embodiments may be combined or eliminated in other embodiments. Further, while advantages associated with certain embodiments of the disclosed technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

To the extent any materials incorporated herein by reference conflict with the present disclosure, the present disclosure controls.

I/We claim:

1. An aerospace system, comprising:
a launch vehicle having a first end and a second end generally opposite the first end, the launch vehicle being elongated along a vehicle axis extending between the first end and the second end;
a propulsion system carried by the launch vehicle and having at least one main engine with a corresponding nozzle positioned toward the first end of the launch vehicle to launch the launch vehicle;
at least one laterally-directed thruster positioned toward the second end of the launch vehicle; and
a controller in communication with the launch vehicle and programmed with instructions that, when executed:
direct the launch vehicle in a first direction during vehicle ascent;
direct the launch vehicle in a second direction, opposite the first direction, during vehicle descent; and
direct activation of the at least one laterally-directed thruster to guide the launch vehicle during descent.

2. The system of claim 1 wherein the at least one laterally-directed thruster is one of multiple laterally-directed thrusters positioned toward the second end of the launch vehicle.

3. The system of claim 2 wherein individual laterally-directed thrusters have corresponding individual nozzles, and wherein the corresponding individual nozzles have corresponding nozzle exits, and wherein the nozzle exits of the individual nozzles are co-planar.

4. The system of claim 2 wherein each of four of the multiple laterally-directed thrusters has a thrust axis pointed in a different direction.

5. The system of claim 2 wherein three of the multiple laterally-directed thrusters have thrust axes pointed in the same direction.

6. The system of claim 1 wherein the at least one laterally-directed thruster is positioned to direct thrust with a lateral component relative to the vehicle axis.

7. The system of claim 1 wherein the at least one laterally-directed thruster is positioned to direct thrust with a non-lateral component relative to the vehicle axis.

8. The system of claim 1 wherein the at least one laterally-directed thruster is has a binary set of thrust settings: off and on.

9. The system of claim 1 wherein the at least one laterally-directed thruster has multiple, non-zero thrust settings.

10. The system of claim 1 wherein the controller is programmed with instructions that, when executed, direct the launch vehicle to translate laterally under a force provided by the at least one laterally-directed thruster, in combination with a force provided the at least one main engine.

11. The system of claim 1 wherein the at least one main engine includes a center main engine and an off-center main engine and wherein the controller is programmed with instructions that, when executed:
direct the launch vehicle to descend under power provided by the off-center main engine and the at least one laterally-directed thruster.

12. The system of claim 1 wherein the controller is programmed with instructions that, when executed, direct the at least one laterally-directed thruster to control an orientation of the launch vehicle after the launch vehicle has landed.

13. The system of claim 1 wherein the controller is programmed with instructions that, when executed, receive an input corresponding to an external force applied to the launch vehicle and direct the at least one laterally-directed thruster to control an orientation of the launch vehicle at least in part in response to the input.

14. The system of claim 1 wherein the controller is programmed with instructions that, when executed, receive an input corresponding to a wind force applied to the launch vehicle and direct the at least one laterally-directed thruster to control an orientation of the launch vehicle at least in part in response to the input.

15. The system of claim 1 wherein the controller is programmed with instructions that, when executed, receive an input corresponding to a tilt angle of a landing site toward which the launch vehicle is traveling, and direct the at least one laterally-directed thruster to control an orientation of the launch vehicle at least in part in response to the input.

16. The system of claim 1 wherein the instructions, when executed, direct activation of the at least one laterally-directed thruster and the at least one main engine to propel the launch vehicle in a direction having a lateral component.

17. The system of claim 1 wherein the instructions, when executed, direct activation of the at least one laterally-directed thruster and the at least one main engine to propel the launch vehicle in a lateral direction.

18. The system of claim 1 wherein the launch vehicle includes a first, booster stage, and wherein the system further comprises a second stage releasably carried by the first stage.

19. A method for operating an aerospace system, comprising:
launching a launch vehicle of the system using thrust from one or more main engines positioned toward a first end of the launch vehicle;
directing the launch vehicle to descend;
controlling descent of the launch vehicle via (a) at least one of the one or more main engines, and (b) at least one laterally-directed thruster, wherein (c) the at least one laterally-directed thruster is spaced apart from the at least one main engine along a longitudinal vehicle axis of the launch vehicle; and
directing the launch vehicle to land with a corresponding nozzle of the at least one main engine facing downward.

20. The method of claim 19 wherein launching the launch vehicle is performed using at least a first of the one or more main engines, and wherein controlling descent of the launch vehicle is performed using a second of the one or more main engines, and not the first.

21. The method of claim 19 wherein controlling descent of the launch vehicle includes responding to varying wind loads on the launch vehicle.

22. The method of claim 19 wherein the at least one laterally-directed thruster includes a plurality of laterally directed thrusters.

23. The method of claim 19, further comprising controlling the at least one laterally-directed thruster by alternating the at least one laterally-directed thruster between only two thrust settings: off and on.

24. The method of claim 19, further comprising controlling the at least one laterally-directed thruster by directing the at least one laterally-directed thruster to produce any of multiple non-zero thrust levels.

25. The method of claim 19 wherein controlling descent of the launch vehicle includes moving the launch vehicle along a vector that is not aligned with the longitudinal axis of the vehicle and has a lateral component and a vertical component.

26. The method of claim 19 wherein controlling descent of the launch vehicle includes moving the launch vehicle laterally while an attitude of the launch vehicle remains generally the same.

27. The method of claim 19 wherein controlling descent of the launch vehicle includes moving the launch vehicle laterally and vertically while an attitude of the launch vehicle remains generally the same.

28. An aerospace system, comprising:
a controller operatively coupleable to a launch vehicle and programmed with instructions that, when executed:
direct the launch vehicle in a first direction during vehicle ascent via thrust from one or more main engines;
direct the launch vehicle in a second direction, opposite the first direction, during vehicle descent; and
direct activation of at least one laterally-directed thruster and at least one of the one or more main engines to move the launch vehicle laterally during descent, wherein the at least one laterally-directed thruster is spaced apart from the at least one main engine along a longitudinal vehicle axis of the launch vehicle.

29. The aerospace system of claim 28, further comprising the launch vehicle.

30. The aerospace system of claim 28 wherein a first one of the one or more main engines is inactive during descent, and wherein the instructions, when executed, direct activation of a second one of the one or more main engines.

31. The aerospace system of claim 28 wherein the instructions, when executed, direct activation of the at least one laterally-directed thruster and the at least one of the one or more main engines in response to an input corresponding to varying wind loads on the launch vehicle.
